(19) United States
(12) Patent Application Publication
(10) Pub. No.: US 2011/0004754 A1
(43) Pub. Date: Jan. 6, 2011

(54) Method And Apparatuses For Authentication And Reauthentication Of A User With First And Second Authentication Procedures

(76) Inventors: John Michael Walker, Den Haag (NL); Susana Fernandez Alonso, Madrid (ES); Mats Näslund, Bromma (SE)

Correspondence Address: ERICSSON INC., 6300 LEGACY DRIVE, M/S EVR 1-C-11, PLANO, TX, 75024, US

(21) Appl. No.: 12/664,650

(22) PCT Filed: Jun. 12, 2007
(86) PCT No.: PCT/EP07/55767

§ 371 Date: Jun. 9, 2010

(51) Int. Cl. H04L 29/06; H04L 9/32

(52) U.S. Cl. 713/168; 726/7

(57) ABSTRACT

A method of authenticating a user to a network, the user being in possession of first and second authentication credentials associated respectively with first and second authentication procedures. The method comprises sending a challenge from the network to the user according to said second authentication procedure, receiving the challenge at the user and computing a response using said first credential or keying material obtained during an earlier running of said first authentication procedure, and said second credential, sending the response from the user to the network, and receiving the response within the network and using the response to authenticate the user according to said second authentication procedure.

### FIELD OF THE INVENTION

The present invention relates to the authentication and reauthentication of users of a communications system.

### BACKGROUND

In a world of converging communication technologies, it is quite possible that a single user terminal will be able to make use of multiple access domains and multiple service levels. As well as using different access domains and services simultaneously, a user may also be able to roam seamlessly between these. Consider for example a mobile wireless terminal which is 3G/GPRS enabled, and which can also access WLAN and WiFi networks. The terminal is able to make “conventional” voice and video calls using a 3G access domain, and can make VoIP calls and multimedia calls over any one of the GPRS, WLAN and WiFi domains. The latter might typically be controlled by an IP Multimedia Subsystem (IMS) network belonging to the 3G/GPRS network operator. Each access domain and service will often require separate authentication of a user before allowing that user to access the access domain or service. This can result in a requirement for multiple authentications even to the same network authentication function.

The Third Generation Partnership Project (3GPP) has specified a protocol known as Authentication and Key Agreement (AKA) for performing authentication and session key distribution in Universal Mobile Telecommunications System (UMTS) networks. UMTS AKA is specified in 3GPP TS.33.102 and is a challenge-response based mechanism that uses symmetric cryptography (i.e. AKA uses a shared secret). AKA is typically run in a UMTS Services Identity Module (USIM), which resides on a smart card like device (referred to as a Universal Integrated Circuit Card or UICC) that also provides tamper resistant storage of shared secrets. AKA is run at registration and re-registration of a User Equipment (UE—where a UE is defined as the combination of a Mobile Station (MS) and a USIM) with its home network. AKA may be employed in 2G networks (i.e. GSM), in which case the UICC will be provisioned with both the USIM and Subscriber Identity Module (SIM) applications. In addition, it had been decided that next generation architectures (including the System Architecture Evolution/Long Term Evolution (SAE/LTE) architecture currently being standardised) will use AKA or an AKA based security protocol.

One of the key objectives of UMTS AKA is to provide for the securing of data on the link between the User Equipment (UE) and an Enforcement Point (EP) where access policy is enforced within the UMTS access network. In the case of a 3G access network, this EP will be within the Radio Network Controller (RNC). In the case of a GSM network the EP will be within the Base Transceiver Station (BTS). In a LTE network, an EP may for example be within a User Plane Entity (UPE) located in the radio base station (eNode B), with possibly multiple EPs present for a single connection. AKA achieves appropriate security levels by delivering to the access network keying material generated using a secret shared K between the USIM on the UE and the Home Location Register (HLR)/Authentication Centre (AuC). N.B. The HLR/AUC enhanced with IP Multimedia Subsystem functionality is referred to as the Home Subscriber Server (HSS).

Considering a packet switched access network, signalling associated with AKA is shown in FIG. 1, where the process is initiated by the UE (a combination of the USIM and the MS) sending an attach request to the SGSN in the access network. The SGSN then requests an Authentication Vector (AV) from the HSS in the UE's home network which in turn requests the AV from an Authentication Centre (AuC). Whilst FIG. 1 shows only the packet switched domain, it will be appreciated that the Visited Location Register (VLR) will perform functions corresponding of the SGSN functions in the circuit switched domain.

Two keys result from the UMTS AKA run, namely a cipher key (C_{K}) and an integrity key (I_{K}). C_{K} and I_{K} are generated at the HSS on the basis of a secret shared between the HSS and the USIM of the UE, and a random value RAND. The HSS also generates an expected result XRES by applying a suitable function to the shared secret and the random value. The keys, together with the RAND value, XRES and an authentication token (AUTN), are sent by the HSS to the SGSN. The SGSN forwards the RAND and AUTN values to the UE where they are delivered to the USIM. The SGSN also passes the keys C_{K} and I_{K} to the enforcement function in the RNC. The USIM authenticates the HSS, and hence verifies the trust relationship between the home network and the SGSN, using the AUTN value. The USIM also generates the keys C_{K} and I_{K} using the RAND value and the shared secret. On the basis of the keys C_{K} and I_{K}, a secure tunnel can be established between the EP within the RNC and the UE. This secures communication over the access network, and in particular the air interface. The USIM also generates a result RES using the shared secret and the RAND value, and returns this to the SGSN. The SGSN compares RES with XRES, and if the two agree traffic is allowed to flow through the secure tunnel.

The provision of specific applications (i.e. services) to a UE will often require that the UE be authenticated to the application server and that a secure channel be established between the UE and the application server via which delivery of a service or application can take place. One might think, for example, of the delivery of a mobile TV service, where media should only be delivered to users that have subscribed to (and paid for) the service.

3GPP Technical Specification TS 33.220 specifies the so-called Generic Bootstrapping Architecture (GBA). GBA provides a mechanism whereby a client terminal (UE) can be authenticated to a Network Authentication Function (NAF)—i.e. the service node or service provider—and secure session keys (Ks_NAF) obtained for use between the UE and the NAF, based upon keys C_{K}′ and I_{K}′ obtained during a re-run of the AKA procedure (this procedure should be distinguished from the initial AKA process run at registration or re-registration of the UE). A Bootstrapping Server Function (BSF) is introduced into the UE's home network, and the AKA re-run is between the UE and the BSF.

AKA can be employed to provide security to and within the so-called IP Multimedia Core Network Subsystem (IMS). IMS is the technology defined by the Third Generation Partnership Project (3GPP) to provide IP Multimedia services over mobile communication networks. The IMS authentication procedure is described on a very high level in FIG. 2. Within the UE, AKA is handled by an IP Multimedia Services Identity Module (ISIM). The AKA protocol performs authentication of the User Equipment (UE) to the S-CSCF and vice versa, and is analogous to the AKA process described above. The Authentication Vector (AV) is obtained by the S-CSCF and the keying material in the AV is delivered to the P-CSCF via the I-CSCF.

It is noted that IMS-AKA is additional to any 3G AKA procedure carried out to authenticate a subscriber to the 3G/GPRS access network. The procedures generate different sets of keying material. In particular, different cipher and integrity keys C_{K}, I_{K} are generated. The IMS-AKA procedure may use the same shared secret relied upon for the 3G/GPRS authentication procedure, or it may be different. However, if the same shared secret is used both for UMTS-AKA and IMS-AKA, then the algorithms used for generating the response and keys must be different.

As already mentioned above, different access domains and different services may use different authentication procedures. In addition to the different “flavours” of AKA used by 3G/GPRS and IMS, WLAN uses EAP based mechanisms, e.g. the EAP TLS or EAP AKA authentication procedures. EAP TLS is a public key infrastructure (PKI) based procedure which uses public-private key pairs that are bound to user identities. Once a session is established between two parties, data to be sent is encrypted using a key derived from a so-called pre-master secret, protected by the public key of the recipient and signed with the private key of the sender.

It is possible that a network operator, or application or service provider, may wish to swap between authentication procedures midway through a session. This is because different authentication procedures typically result in different encryption schemes which are more or less bandwidth efficient. So, for example, where a session is established over a high bandwidth access network,

PKI may be used to initially authenticate the user to the network operator. If the user then roams into a low bandwidth access network where a further authentication is required, it may be desirable to reauthenticate the user with an AKA procedure as AKA generally involves a lower signalling overhead. Such a scenario may arise where a user is using an IMS service, and switches from a WLAN access network to a 3G/GPRS access network. Another reason for changing authentication method might be security related. For example, one provider may assign higher trust in a shared key method than a PKI based method. Moreover, two authentication methods of the same “flavour” might differ in key size and hence also in terms of security level.

### SUMMARY

It is recognised that, where reauthentication of a user is required, it may be desirable to link the new authentication with the previous authentication. This may be for example because a first authentication method (e.g. AKA based) is used as a basis for charging, whilst a second authentication method (e.g. PKI based) is service-specific. If robust charging is to be obtained, it must be possible to assert that the second authentication method was carried out by the same user that previously used the first method. A naive approach to linking may be, in the case of a MS provided with USIM and possessing a PKI certificate, to include the user's IMSI within the PKI certificate. The problem with this approach however is that anyone in possession of the certificate can link to an earlier AKA authentication, regardless of whether or not that person actually instigated the AKA authentication.

According to a first aspect of the present invention there is provided a method of authenticating a user to a network, the user being in possession of first and second authentication credentials associated respectively with first and second authentication procedures. The method comprises sending a challenge from the network to the user according to said second authentication procedure, receiving the challenge at the user and computing a response using said first credential or keying material obtained during an earlier running of said first authentication procedure, and said second credential. The response is then sent from the user to the network and, upon receipt of the response within the network, the network uses the response to authenticate the user according to said second authentication procedure.

Embodiments of the invention provide a secure and robust mechanism for linking authentication procedures of the same or different type.

Each of said first and second authentication procedures may be an authentication and key agreement procedure, with each of said first and second credentials being a secret shared between the network and the user.

Said first authentication procedure may be an authentication and key agreement procedure, with said first credential being a secret shared between the network and the user, and said second authentication procedure may be a public key infrastructure procedure, with said second credential being a private key of a public-private key pair.

Said second authentication procedure may an authentication and key agreement procedure, with said second credential being a secret shared between the network and the user, and said first authentication procedure may be a public key infrastructure procedure, with said first credential being a private key of a public-private key pair.

Each of said first and second authentication procedures may be a public key infrastructure procedure, with each of said first and second credentials being a private key of a corresponding public-private key pair.

Typically, said challenge contains a nonce, and said step of computing a response comprises using the nonce to compute the response.

The method may comprise sending said challenge together with an indication that the second procedure is to be linked to the first procedure. Said indication may further identify the first procedure. For example, said indication may be a RAND value associated with an AKA procedure, or a key set identifier” (KSI) and/or IMSI/TMSI.

In a preferred embodiment of the invention, said first authentication procedure may be an access network authentication procedure, and said second authentication procedure may be an IP Multimedia Subsystem authentication procedure.

According to a second aspect of the present invention there is provided a user terminal configured to run first and second authentication procedures with a network and to store respective first and second authentication credentials. The terminal is configured to receive a challenge from the network according to said second authentication procedure, compute a response using said first credential or keying material obtained during an earlier running of said first authentication procedure, and said second credential, and send the response to the network. The terminal may be a wireless terminal comprising, for example, a universal Integrated circuit card provided with a USIM for running one or both of said first and second authentication procedures.

According to a third aspect of the present invention there is provided a network node configured to authenticate a network user, the network node being configured to send a challenge to the user according to a second authentication procedure, receive a response to said challenge from the user, and authenticate the response using a second credential associated with said second authentication procedure and a first credential or keying material obtained during an earlier running of a first authentication procedure between the network and the user. The network node may be a Serving CSCF of an IP multimedia subsystem.

### BRIEF DESCRIPTION OF THE DRAWINGS

FIG. 1 shows signalling associated with an Authentication and Key Agreement procedure in the packet domain conducted between a user equipment and a home domain, via an access network;

FIG. 2 illustrates an IMS authentication procedure for User Equipment;

FIG. 3 illustrates signalling associated with User Equipment conducting successive authentications via access networks AN_1 and AN_2 respectively;

FIG. 4 illustrates schematically processes for generating keying material for first and second authentication procedures at AN_1 and AN_2;

FIG. 5 illustrates schematically processes for generating keying material for first and second authentication procedures at a client;

FIG. 6 illustrates signalling associated with a specific application of a linked authentication procedure;

FIG. 7 illustrates schematically an embodiment of the present invention in which a counter or condition is used to update a link-key;

FIG. 8 illustrates signalling associated with a mobile terminal which is authenticated using a USIM when attaching to a network and, at a later time, requests a download from an application server;

FIG. 9 illustrates signalling associated with an embodiment for generating AKA session keys using keying material resulting from a previously run PKI procedure; and

FIG. 10 is a flow diagram illustrating a generic method for linking authentication procedures.

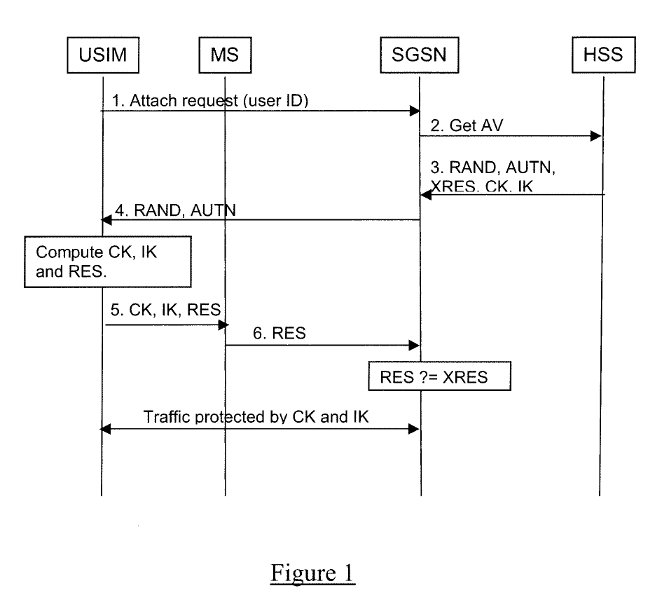

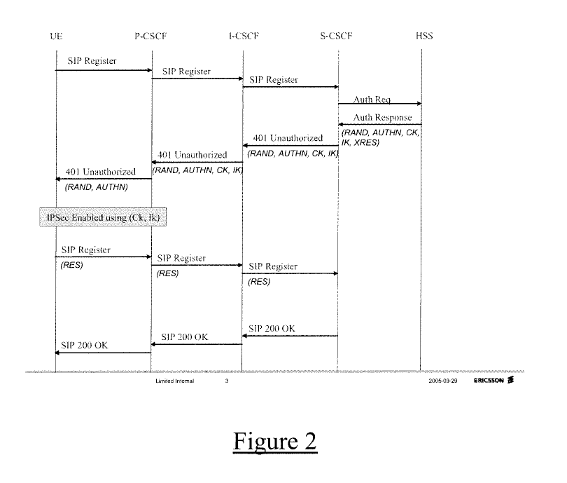

### DETAILED DESCRIPTION

Four example procedures which involve the linking of a first and a second authentication are considered here. These are:

1. Both the first and second authentication are based on shared keys, but use different keys and/or methods/algorithms.

2. The first authentication is PKI based and the second is shared key based.

3. The first authentication is shared key based and the second is PKI based.

4. Both the first and second authentication are PKI based but use different keys and/or methods/algorithms.

Consider the case where a mobile wireless terminal, referred to below as User Equipment (UE), possesses two symmetric keys (Ki, Kj) for different symmetric key based Authentication and Key Agreement (AKA) protocols. In the case of a 3G UE, one or both of the keys may be stored on a Universal Integrated Circuit Card (UICC) of the UE. As already noted, when changing authentication procedures and keys, it may be of interest to “link” the procedures together, making sure that the UE being authenticated with key Kj is the same UE that was previously authenticated with Ki.

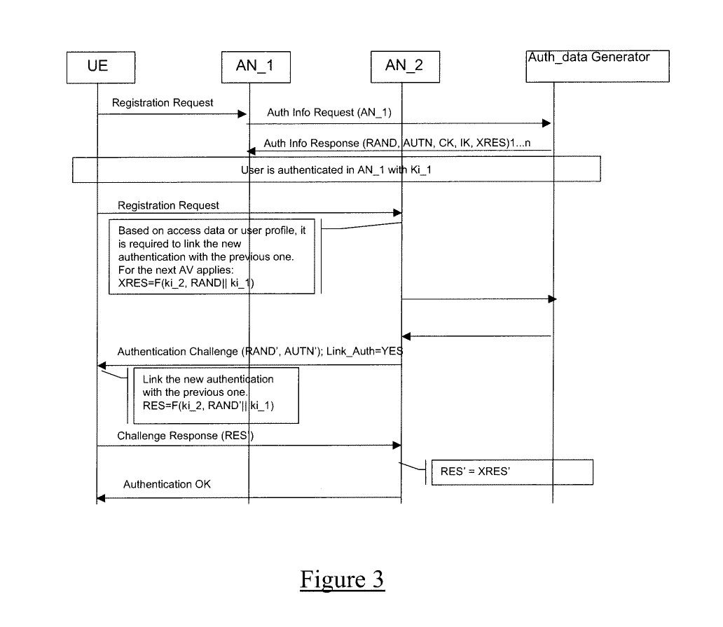

FIG. 3 illustrates signalling associated with the UE conducting successive authentications via access networks AN_1 and AN_2 respectively. On the network side, authentication data is generated for both procedures by an authentication data generator (Auth-data generator). The generator possesses both symmetric keys Ki, Kj.

A first AKA procedure (based on Ki) will produce a response RES on the part of the UE, computed using the key Ki and the RAND value provided by a network-based authentication data generator (i.e. RES=F(Ki, RAND). The UE and AN_1 will share session keys Ck, Ik. Assuming that the UE is correctly authenticated by AN_1 (i.e. RES=XRES), the UE can initiate calls/sessions via AN_1.

Assume now that the UE wishes to switch access networks, and attaches to AN_2. This requires execution of a new authentication procedure that requires a different key (Kj in this case). The authentication data generator will determine whether or not it is required to link the new authentication to the previous one. This decision can for example be based upon the type of access network, subscriber capabilities, etc. As this new authentication will use a different key, new vectors need to be generated. The authentication generator sends a new authentication vector to AN_2 which contains a new random value RAND′. The vector also contains a linking indicator (Link_Auth) to indicate that the new authentication must be linked to the previous authentication. Alternative mechanisms for indicating to the UE that linking is required include using the “key set identifier” (KSI) and/or IMSI/TMSI. Each run of the AKA protocol is associated with an identifier for that particular run in the form of a KSI. Thus, the presence of the KSI/TMSI in the (re-authentication) signalling would indicate to the UE that linking is required and, in the case of KSI, it also identifies which previous authentication to use. Another possibility is to use the RAND used on the first AKA as an indicator. For example, if the RAND value starts with a specific pattern, e.g. “1 . . . ”, this would indicated to the UE that linking is required whereas RAND of form “0 . . . ” would indicate that no linking is required. A still further possibility is that when a user requests the second authentication, it provides the RAND used in the first authentication. This RAND will be used in the generation of the Link_Key in the operator network. In this case, the Link_Key should be different from CK and IK, for security purposes.

According to conventional AKA, AN_2 receives the authentication vector and forwards RAND′ (and AUTN) to the UE. The linking indicator is also sent to the UE. Upon determining that linking is required, the UICC calculates:

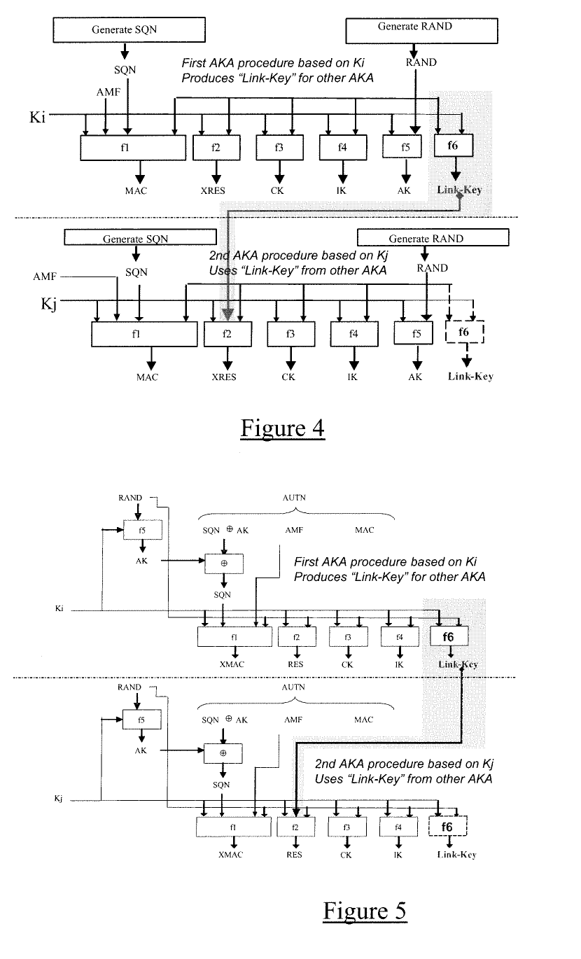

RES′=G(Kj, RAND′∥old_key).

Where “old_key” is keying material previously generated by the UE during the first authentication procedure. (The function G may or may not be the same as the function F used together with Ki above.) Typically, old_key will be Ki or a key derived therefrom. However, a special case is where Ki=Kj, in which case old_key is a key specifically generated using the first authentication procedure.

Where old_key is not Ki, it may be one of the old Ck, Ik keys. Preferably however, it is a separate key, here called “Link-Key” where Link-Key=f6(Ki, RAND), produced by AKA and used only for this linkage purpose (and never used directly over the air interface, thus reducing the risk that security is compromised). FIG. 4 illustrates schematically processes for generating keying material for the first and second authentication procedures at AN_1 (above the dashed line) and AN_2 (below the dashed line), using Ki and Kj. In the Figure, f1 to f6 are appropriate cryptographic functions, e.g. AES, HMAC, SHA-256 etc. Note that the functions f1 to f5 in FIG. 4 are already part of the standard UMTS AKA procedures used to process parameters, “AK”, “SQN” etc. SQN and AK represents respectively a sequence number and a key used for replay protection and network authentication purposes. Other terms used in the Figure have been identified previously.

As is clear from FIG. 4, the “Link-Key” is produced by the first AKA procedure, by the function f6, and is then fed forward into the function creating XRES (in the authentication server) and RES (on the terminal, USIM, UICC, smartcard, etc). [Note that it would be possible to link N different authentication vector generation procedures in this manner.] The second AKA procedure will be successful only if RES=XRES, where RES and XRES are generated using f2(Kj, RAND II Link_key), with f2 as shown in FIG. 4. Hence, if the first AKA procedure did not complete successfully, then the second procedure will fail. Of course, rather than use a Link-key, or Ki, Ck, or Ik, any suitable combination of the old keying material may be used instead. FIG. 5 illustrates schematically the corresponding processes for generating keying material for the first and second authentication procedures at the client (first procedure above the dashed line and second procedure below the dashed line).

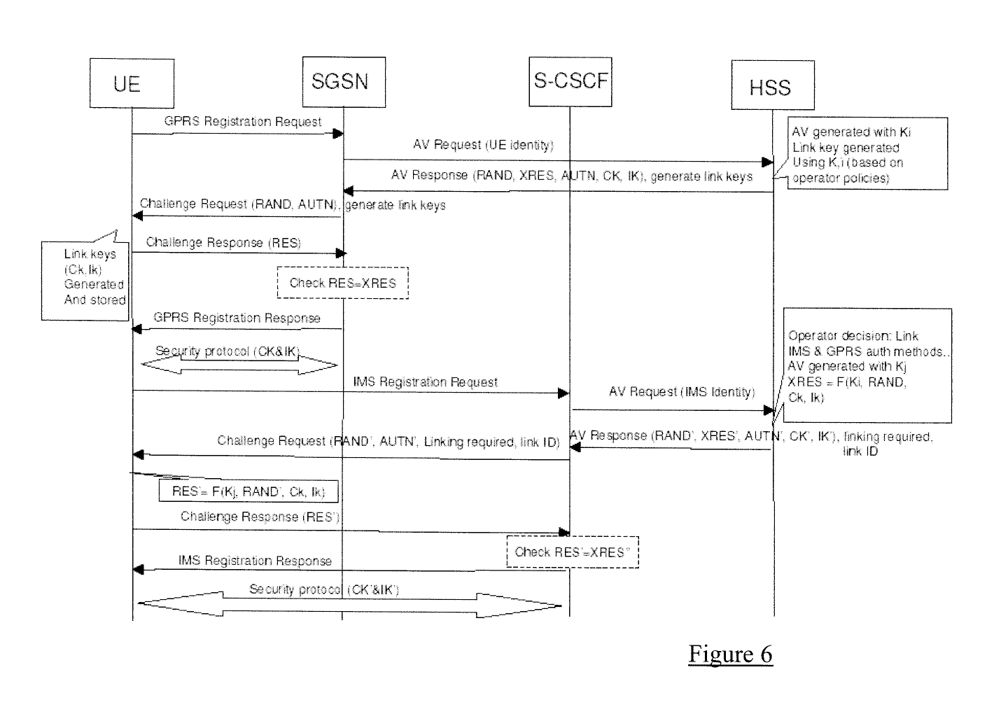

FIG. 6 illustrates signalling associated with a specific application of the linked authentication procedure described above. In this example, AN_1 is a GPRS network, where it is the SGSN within the GPRS network that performs the first authentication procedure using an authentication vector received from the HSS. AN_2 is an IMS network, where it is the S-CSCF that performs the second authentication procedure using an authentication vector also received from the HSS.

It is possible for a given client to support both PKI and shared key based authentication procedures such as AKA. In this case, the client possesses a public key PK and a corresponding secret (private) key SK. The client also possesses a symmetric key Ki for AKA. Assume that the client comprises a UICC and that the keys PK, SK, and Ki are all stored on the UICC. Suppose that the client has already been authenticated using the AKA based procedure and that it is now required to authenticate the client using the PKI based procedure. At the same time, it is required that the PKI based authentication is made in respect of the same client previously authenticated using the AKA procedure, i.e. the client possessing the USIM and the key Ki.

The AKA run will have resulted in the USIM producing keys, Ck, Ik. The PKI based authentication procedure re-uses these or related keying material. For example, when the network provides to the client a PKI challenge R to be signed, the client signs not only R, but also a function dependent on keying material generated by the AKA procedure. For example, the client may generate the signature Sign(SK, R∥MAC(Ik, R)), where MAC is a (secure) message authentication code. Only a client knowing both SK and Ik would be able to produce this signature. Notice also that on the network side, only a party knowing Ik will be able to verify the signature, in contrast to “normal” PKI where anyone can verify the authentication (assuming that they possess the public key PK). This could be desirable from a business point of view as it gives the operator a more central role as “authenticator”.

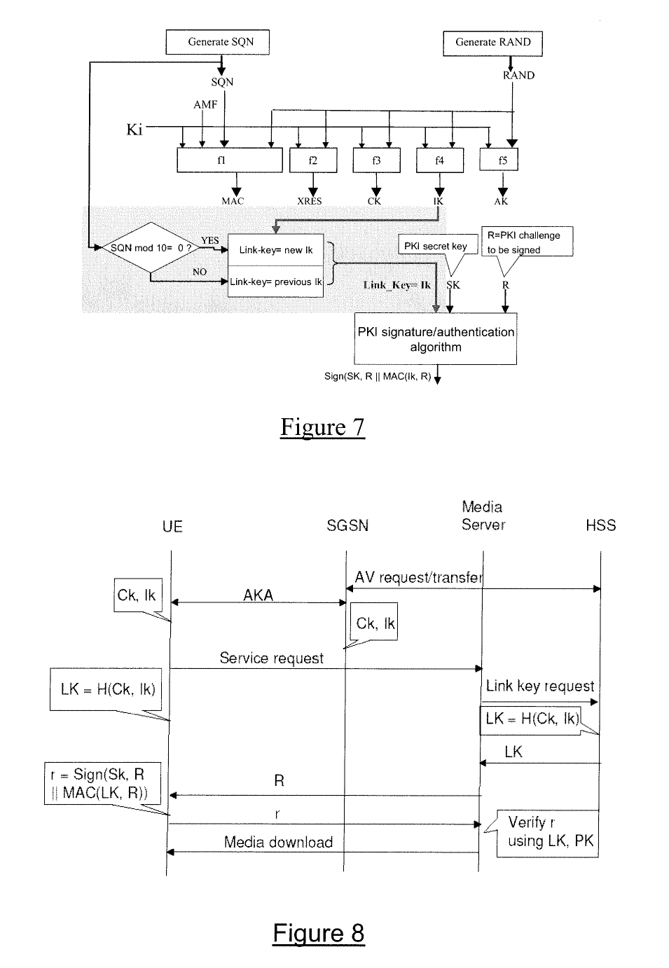

It is of course important that the PKI application in both the client and the network make use of the same AKA session key Ik (Ik will vary in each new AKA authentication vector) or other (AKA related) key for the authentication linking to be successful. FIG. 7 illustrates schematically an embodiment in which a counter or condition is used to update the link-key only every 10th Ik key on the client and in the network. This approach reduces the risk of the client and the authenticator loosing synchronisation (which might be especially problematic where re-authentications are carried out frequently in respect of a given procedure).

Consider the case where a mobile terminal is first authenticated using a USIM when attaching to the network, and at a later time requests a music (e.g. MP3) download from an application server. For DRM (Digital Rights Management) purposes, this application server may wish to authenticate the terminal to ensure that it complies with copy protection. Typically, this latter authentication is based on a PKI associated with the device manufacturer. FIG. 8 illustrates signalling associated with this procedure. This embodiment also uses a separate link key, LK, derived from Ck, Ik. The advantage of this approach is that the PKI procedure can be linked to the subscriber (USIM) authentication to provide robust charging for the download.

Consider now the case where a client is first authenticated using a PKI based procedure, and it is required to link the public key PK of the client to the USIM. To this end, the AKA challenge, RAND, is encrypted on the network side using the public key of the client, i.e.

RAND′=Encr(PK, RAND).

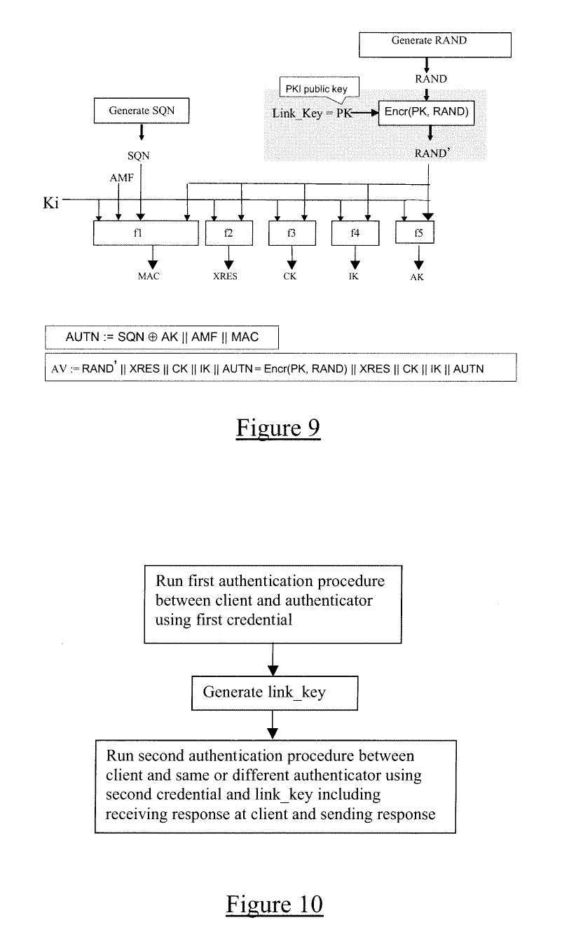

Note that in this case the link_key takes on the value of PK in order to link PKI with AKA. RAND′ and XRES (and other AKA parameters) are sent to the VPLMN. Upon reception of RAND′, the client decrypts it using SK, and obtains RAND which is fed to the USIM. The resulting RES is sent to the access network which compares it to XRES. Only simultaneous possession of both the USIM and the secret SK would allow a correct response to be generated. FIG. 9 illustrates schematically an embodiment for generating AKA session keys using keying material resulting from a previously run PKI procedure.

It is possible to include additional information into the RES generation process to improve further the linkage of the PKI and AKA procedures. For example, the “timestamp” used in PKI could be used as input to AKA. Conversely, the SQN used in AKA could be an input to the PKI procedure.

A further embodiment of the invention involves a client possessing two PKI key pairs, PK1, SK1 and PK2, SK2. If a first PKI authentication procedure creates symmetric keys for data protection similar to Ck, Ik, one or both of these keys can be included into the second PKI authentication as the link-key (as described above—see FIG. 7). If not, something else must be done as there is no other “secret” information that only the client and network know. The only information that is shared is an authentication challenge (corresponding to R above), a response, and a public key, all of which could in principle be known to anybody. A solution to this problem is to issue a double response, i.e. when the client receives a challenge, it “signs” it with both secret keys SK1 and SK2 to produce the response. Of course, the size of the response is doubled.

FIG. 10 is a flow diagram illustrating the generic method described above.

It will be appreciated by those of skill in the art that various modifications may be made to the above described embodiments without departing from the scope of the present invention.

1. A method of authenticating a user to a network, the user being in possession of first and second authentication credentials associated respectively with first and second authentication procedures for authenticating the user to the network, wherein said first authentication procedure does not require said second authentication credential, the method comprising:
sending a challenge from the network to the user according to said second authentication procedure;
receiving the challenge at the user and computing a response using said first credential or keying material obtained during an earlier running of said first authentication procedure, and said second credential sending the response from the user to the network; and
receiving the response within the network and using the response to authenticate the user according to said second authentication procedure.

2. The method according to claim 1, wherein each of said first and second authentication procedures is an authentication and key agreement procedure and each, of said first and second credentials is a secret shared between the network and the user.

3. The method according to claim 1, wherein said first authentication procedure is an authentication and key agreement procedure and said first credential is a secret shared between the network and the user, and wherein said second authentication procedure is a public key infrastructure procedure and said second credential is a private key of a public-private key pair.

4. The method according to claim 1, wherein said second authentication procedure is, an authentication and key agreement procedure and said second credential is a secret shared between the network and the user and wherein said first authentication procedure is a public key infrastructure procedure and said first credential is a private key of a public-private key pair.

5. The method according to claim 1, wherein each of said first and second authentication procedures is a public key infrastructure procedure and each of said first and second credentials is a private key of a corresponding public-private key pair.

6. The method according to claim 1, wherein said challenge contains a nonce, and said step of computing a response comprises using the nonce to compute the response.

7. The method according to claim 1 and comprising sending said challenge together with an indication that the second procedure is to be linked to the first procedure.

8. The method according to claim 7, wherein said indication identifies the first procedure.

9. The method according to claim 8, wherein said indication comprises one of:
a RAND value associated with an AKA procedure;
a key, set identifier (KSI) and/or IMSI/TMSI.

10. The method according to claim 1, wherein said first authentication Procedure is an access network authentication procedure, and said second authentication procedure is an IP Multimedia Subsystem authentication procedure.

11. A user terminal configured to run first and second authentication procedures with a network in order to authenticate the user to the network, and to store respective first and second authentication credentials, wherein said first authentication procedure does not require said second authentication credential, the terminal being configured to:
receive a challenge from the network according to said second authentication procedure;
compute a response using said first credential or keying material obtained during an earlier running of said first authentication procedure, and said second credential; and
send the response to the network.

12. The user terminal according to claim 11, the terminal being a wireless terminal.

13. The user terminal according to claim 11, said first procedure being, one of an authentication and key agreement procedure and a public key infrastructure procedure.

14. The user terminal according to claim 11, said second procedure being one of an authentication and key agreement procedure and a public key infrastructure procedure.

15. The user terminal according to claim 1 and comprising a universal integrated circuit card on which is stored one or both of said first and second authentication credentials.

16. The user terminal according to claim 15, said universal Integrated circuit card being provided with a USIM for running one or both of said first and second authentication procedures.

17. A network node configured to authenticate a network user, the network node being configured to:
send a challenge to the user according to a second user authentication procedure;
receive a response to said challenge from the user; and
authenticate the response using a second credential associated with said second authentication procedure and a first credential or keying material obtained during an earlier running of a first user authentication procedure between the network and the user, wherein said first authentication procedure does not require said second authentication credential.

18. The network node according to claim 17, the network node being a Serving CSCF of an IP multimedia subsystem.
